(19) United States
(12) Patent Application Publication
(10) Pub. No.: US 2011/0032649 A1
(43) Pub. Date: Feb. 10, 2011

(54) ESD PROTECTIVE DEVICE HAVING LOW CAPACITANCE AND STABILITY AND A PREPARING PROCESS THEREOF

(75) Inventors: Chung-Kook Lee, Daejeon (KR); Won-Kyoung Lee, Daejeon (KR)

Correspondence Address: CANTOR COLBURN LLP, 20 Church Street, 22nd Floor, Hartford, CT, 06103, US

(73) Assignee: LATTRON CO., LTD, Daejeon (KR)

(21) Appl. No.: 12/988,172

(22) PCT Filed: Aug. 26, 2008
(86) PCT No.: PCT/KR2008/004998

§ 371 Date: Oct. 15, 2010

(30) Foreign Application Priority Data
Apr. 15, 2008 (KR) 10-2008-0034808

(51) Int. Cl. H02H 9/04; B41M 1/12

(52) U.S. Cl. 361/56; 101/129

(57) ABSTRACT

An ESD protective device having a low capacitance and stability characteristics constructed by installing a voltage sensitive material between electrodes. The voltage sensitive material comprises a fluorescent substance. The voltage sensitive material may be barium aluminate. The voltage sensitive material may be zinc silicate. The voltage sensitive material may be zinc sulfide. The voltage sensitive material is doped with a metal atom such as Mn, Cu and Eu. The device does not distort a signal wave pattern and have low capacitance of 0.5 pF or lower.

### TECHNICAL FIELD

The present invention relates to an ESD protective device having a low capacitance and stability and a preparing process thereof, more particularly to an ESD protective device having a low capacitance and stability and a simplified preparing process thereof, as compared to conventional ones, by using a voltage sensitive material which surmounts difficulty in forming the voltage sensitive material that has been used in production of an ESD protective device.

### BACKGROUND ART

As shown at FIG. 1, there has been the structure in which an electrode is installed in the same plane or in a stacked form on a substrate and voltage protection material is installed therebetween in the prior art. Referring to FIG. 2, it has been used the voltage protection material which is produced by mixing at least two kinds of a semiconductive ceramic powder (for example, ZnO) and a conductive powder.

As shown at FIG. 3, in the prior art, a voltage protection material results in formation of a non linear resistance layer on the surface of a semiconductive ceramic during calcination (solid phase reaction) process, and such process has been functioned very importantly.

This is due to the reason that the non linear resistance layer functions as the key of a voltage sensitive material.

However, there has been a drawback that it is difficult to control the process during the calcination process.

Namely, there has been a drawback that an ESD protective characteristic is changed or do not operate in case where they face severe condition when thickness and components of a non linear resistance layer are changed by change of calcination process.

ZnO—based ceramic materials have a considerable defect in its permittivity so that it is beyond its capacity to employ it since an ESD protective device can not generally meet super low capacitance of 0.5 pF or lower when it is applied to high signal line.

To solve the problem, the construction shown at FIG. 4 has been proposed. A dielectric layer (332) is installed and an opening member (335) of the dielectric layer is formed with a small size to embody low capacitance. However, its process becomes difficult since a dielectric layer is introduced.

Additionally, there is a drawback that there is a limitation in selection of a voltage sensitive material since a matching property (thermal expansion, chemical reaction) between a dielectric layer and a voltage sensitive material (320) should be considered.

### DISCLOSURE

### [Technical Problem]

Therefore, the present invention has been proposed by considering the problem in the prior art. The object of the present invention is to make it easy to embody a characteristic and simultaneously embody a characteristic of ESD parts stably by providing a voltage sensitive material which utilizes property of particles itself but not property of grain boundary when preparing a voltage sensitive material being used in production of an ESD protective device different from ZnO based semiconductive ceramic materials utilizing property of grain boundary like prior art when preparing a voltage sensitive material.

The other object of the present invention is to provide an excellent property which does not distort a signal wave pattern when using as an ESD protective device of high signal line such as USB2.0, HDMI and the like by enabling to embody low capacitance of 0.5 pF or lower with providing a low permittivity.

### [Technical Solution]

To solve the objects, an ESD protective device capable of embodying a low capacitance and stability characteristics according to one embodiment of the present invention is constructed by installing a voltage sensitive material between electrodes, the device being characterized in that the voltage sensitive material is a fluorescent substance.

According to the other aspect, the preparing process of an ESD protective device enabling to embody a low capacitance and stability characteristics is characterized in that it comprises;

an electrode printing process which screen-prints an electrode on a substrate;

a pasting process which produces a voltage sensitive material in paste form; and

a paste printing process which screen-prints the paste of voltage sensitive material.

### ADVANTAGEOUS EFFECTS

As above-illustrated, an ESD protective device capable of embodying a low capacitance and stability characteristics and a preparing process thereof according to the present invention make it possible to embody a characteristic easily and embody a characteristic of ESD parts stably since a voltage sensitive material utilizes property of particles itself but not property of grain boundary when preparing a voltage sensitive material being used in production of an ESD protective device different from ZnO based semiconductive ceramic materials utilizing property of grain boundary like prior art when preparing a voltage sensitive material, and provide an excellent property which does not distort a signal wave pattern when using as an ESD protective device of high signal line such as USB2.0, HDMI and the like since its permittivity is low so that it enables to embody low capacitance of 0.5 pF or lower.

### DESCRIPTION OF DRAWINGS

FIG. 1 is a diagrammatic overall view of construction that a conventional voltage protection material is installed.

FIG. 2 is a view showing the voltage protection material which is produced by mixing at least two kinds of a semiconductive ceramic powder and a conductive powder in the prior art.

FIG. 3 is a view showing the producing process of a conventional voltage protection material.

FIG. 4 is a view showing a device which embodies a conventional low capacitance.

FIG. 5 is a view showing an ESD protective device capable of embodying a low capacitance and stability characteristics according to one embodiment of the present invention.

FIG. 6 is a view showing protective property when installing an ESD protective device having a low capacitance and stability characteristics according to one embodiment of the present invention.

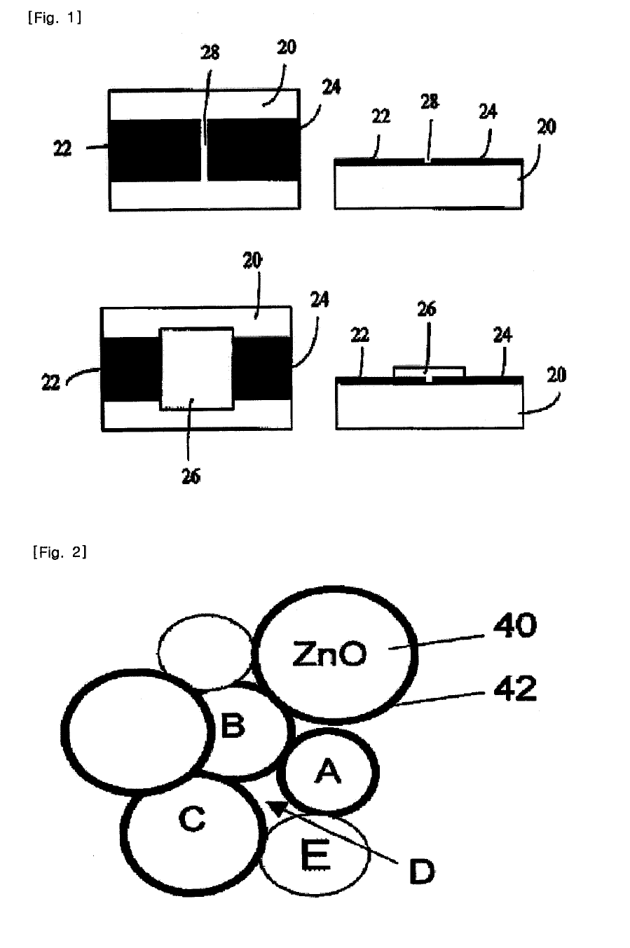

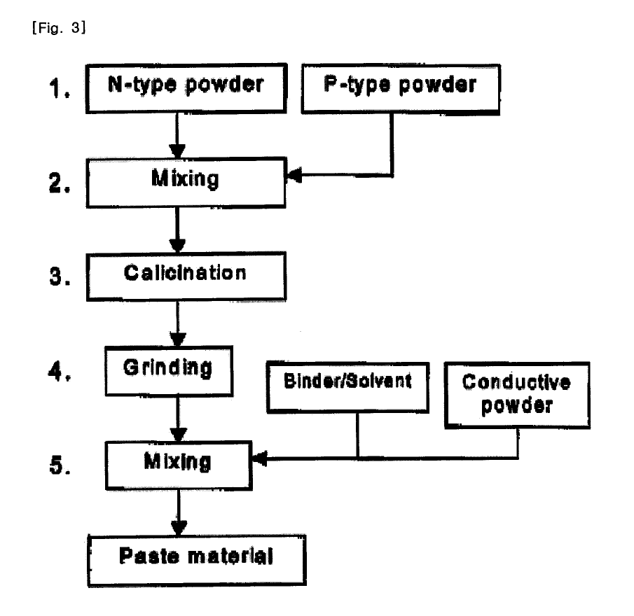

### BEST MODE

To solve the object, an ESD protective device having a low capacitance and stability characteristics according to one embodiment of the present invention is constructed by installing a voltage sensitive material between electrodes, the device being characterized in that the voltage sensitive material is a fluorescent substance.

According to one embodiment, the voltage sensitive material is barium aluminate oxide.

According to one embodiment, the voltage sensitive material is sulfide such as ZnS.

According to one embodiment, the voltage sensitive material is doped with a metal atom such as Mn, Cu and Eu.

According to one embodiment, the thickness of the voltage sensitive material is 3˜100 μm.

On the other hand, the preparing process of an ESD protective device capable of embodying a low capacitance and stability characteristics according to the present invention is characterized in that it comprises;

an electrode printing process which screen-prints an electrode on a substrate;

a pasting process which produces a voltage sensitive material in paste form; and

a paste printing process which screen-prints the paste of voltage sensitive material.

According to one embodiment, a binder is added at the pasting process and the binder is glass.

According to one embodiment, the binder is epoxy.

According to one embodiment, the mixing ratio (by weight) at the pasting process is a voltage sensitive material powder:binder:vehicle=1:0.3:1.

The present invention will now be illustrated by the following non-limiting examples for an ESD protective device having a low capacitance and stability characteristics and a preparing process thereof.

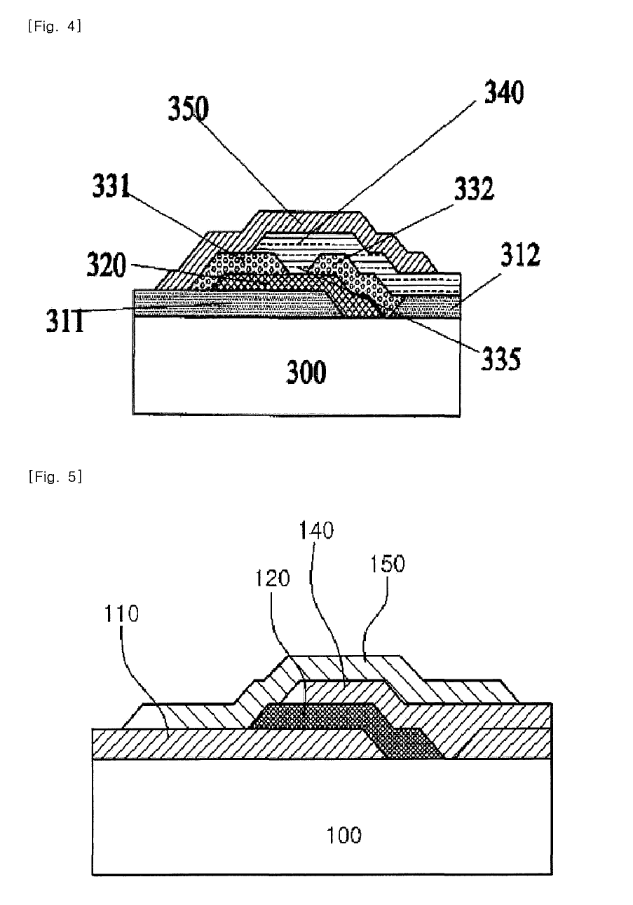

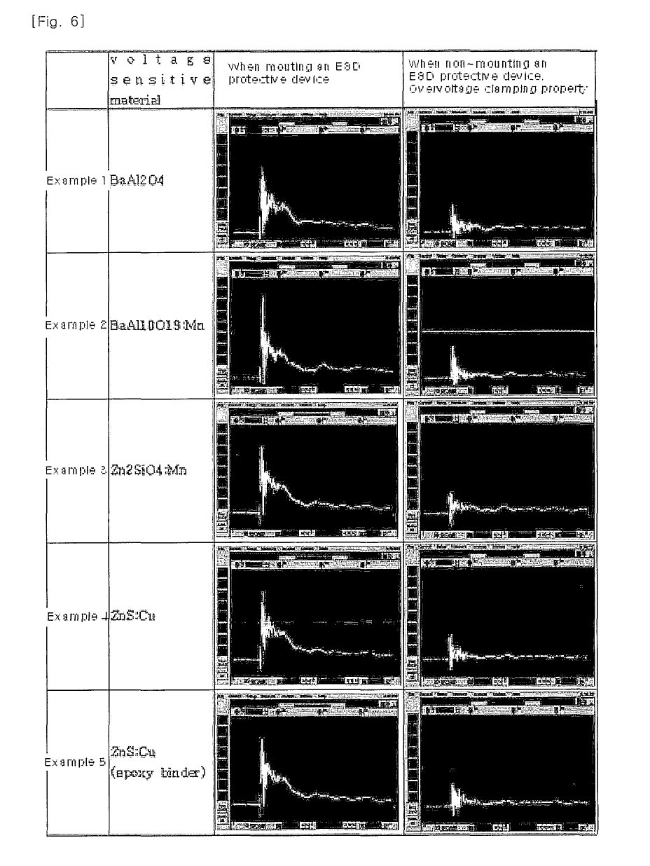

FIG. 5 is a sectional view showing an ESD protective device enabling to embody a low capacitance and stability characteristics according to one embodiment of the present invention.

As illustrated at FIG. 5, an ESD protective device having a low capacitance and stability characteristics according to the present invention is constructed by forming a conductive electrode (110), a voltage sensitive material (120), a conductive electrode (140), and a protective layer (150) on a substrate made of alumina or FR-4, using a screen-printing method.

At this time, an ESD protective device according to the present invention is produced by heat treatment at 850° C. after each of the formations in the above order with a screen-printing method.

More particularly, an electrode and a voltage sensitive material are produced in a paste form and then used according to a conventional method. At the process for preparing a paste, it is heat-treated and baked at 500˜900° C. when using a glass as a binder (examples 1˜4), and it is cured at 80˜250° C. when using ethyl cellulose or epoxy as a binder (example 5).

The binder can be properly selected in such a manner that it meets easiness in preparing process or non-use of a particular harmful atom such as Pb, Cd and the like (ROHS).

The present invention will be further illustrated by the following examples.

### Example 1

To produce a voltage sensitive material, BaCO₃ and Al₂O₃ are weighed to be 1:1 of molar ratio, and mixed together with ethyl alcohol as a solvent with a wet-process for 24 hours, and then calcined at 1350° C. for 2 hours to synthesize to form BaAl₂O₄. The obtained BaAl₂O₄ is wet-pulverized in the same way to be about 3.0 μm of D50 and dried to obtain a powder for a voltage sensitive material.

Thereafter, a glass of Zn-Bi series as a binder and a vehicle produced by melting ethyl cellulose into BCA are used to produce a voltage sensitive material paste.

The mixing ratio (by weight) at production of the paste is as follows:

voltage sensitive material powder:binder:vehicle=1:0.3:1.

Then, an ESD protective device is obtained by forming a conductive electrode (110), a voltage sensitive material (120), a conductive electrode (140), and a protective layer (150) on a substrate (100) in the described order using a screen-printing method and by heat-treating at 850° C.

### Example 2

By following the same procedure as in the example 1, except that a green fluorescent substance for a conventional PDP is used as BaAl₁₀O₁₉:Mn and D50 is about 3.0 μm, an ESD protective device is produced.

### Example 3

By following the same procedure as in the example 1, except that a green fluorescent substance for a conventional PDP is used as Zn₂SiO₄:Mn and D50 is about 3.0 μm, an ESD protective device is produced.

### Example 4

By following the same procedure as in the example 1, except that a green fluorescent substance for a conventional inorganic EL(electro-luminescence) is used as ZnS:Cu and D50 is about 3.0 μm, an ESD protective device is produced.

### Example 5

By following the same procedure as in the example 4, except that epoxy is used as a binder at a process for preparing a paste, and the temperature of heat treatment is 200° C. , an ESD protective device is produced.

Thereafter, IEC61000-4-2 pulse (peak voltage 8KV, peak current 30 A) according to IEC prescription is applied to an electrode (110 or 140) of parts to measure an ESD protective property of the parts.

As shown at FIG. 6 for the examples 1-5, it can be seen that the ESD protective device produced by using a voltage sensitive material according to the present invention operates as the ESD protective device clamping a peak voltage to 50% or lower with respect to an ESD of 8KV-30 A prescribed at IEC61000-4-2.

Also, it can be confirmed that a property of capacitance is realized to a low capacitance of 0.5 pF or lower (being measured at 1 MHz) at all cases of the examples 1˜5.

With the above described construction and operating principle, the present invention makes it possible to embody a characteristic easily and embody a characteristic of ESD parts stably since a voltage sensitive material utilizes property of particles itself but not property of grain boundary when preparing a voltage sensitive material being used in production of an ESD protective device different from ZnO based semiconductive ceramic materials utilizing property of grain boundary like the prior art when preparing a voltage sensitive material, and provide an excellent property which does not distort a signal wave pattern when using as an ESD protective device of high signal line such as USB2.0, HDMI and the like since its permittivity is low so that it enables to embody low capacitance of 0.5 pF or lower.

It should be understood that various modifications of the invention in addition to those described herein will become apparent to those skilled in the art from the foregoing description and the accompanying figures. Therefore, the invention is in no way limited to the preferred embodiments, which have been given solely by way of illustration and without implying a limitation.

The scope of the present invention is not to be limited by the specific embodiments described herein but the appended claims. Indeed, it should be understood that various modifications derived from a concept equivalent to claims are intended to fall within the scope of the appended claims.

### INDUSTRIAL APPLICABILITY

The present invention, an ESD protective device having a low capacitance and stability characteristics and a preparing process thereof makes it possible to embody a characteristic easily and embody a characteristic of ESD parts stably, and provide an excellent property which does not distort a signal wave pattern when using as an ESD protective device of high signal line such as USB2.0, HDMI and the like since its permittivity is low so that it enables to embody low capacitance of 0.5 pF or lower. Therefore, it may be useful for the field of an ESD protective device.

1. An ESD protective device having a low capacitance and stability characteristics constructed by installing a voltage sensitive material between electrodes, wherein the voltage sensitive material comprises a fluorescent substance.

2. An ESD protective device having a low capacitance and stability characteristics according to claim 1, wherein the voltage sensitive material comprises barium aluminate.

3. An ESD protective having a low capacitance and stability characteristics according to claim 1, wherein the voltage sensitive material comprises zinc silicate.

4. An ESD protective device having a low capacitance and stability characteristics according to claim 1, wherein the voltage sensitive material comprises zinc sulfide.

5. An ESD protective device having a low capacitance and stability characteristics according to claim 1, wherein the voltage sensitive material is doped with a metal atom such as Mn, Cu and Eu.

6. An ESD protective device having a low capacitance and stability characteristics according to claim 1, wherein a thickness of the voltage sensitive material is 3˜100 μm.

7. A preparing process of an ESD protective device having a low capacitance and stability characteristics, comprising;
an electrode printing process which forms an electrode on a substrate through screen-printing;
a pasting process which produces a voltage sensitive material paste in a paste form; and
a paste printing process which screen-prints the paste of voltage sensitive material.

8. A preparing process of an ESD protective device having a low capacitance and stability characteristics according to claim 7, wherein a binder is added in the pasting process and the binder is glass.

9. A preparing process of an ESD protective device having a low capacitance and stability characteristics according to claim 7, wherein an organic binder is added in the pasting process and the binder is epoxy.

10. canceled
